(19) United States
(12) Patent Application Publication
(10) Pub. No.: US 2003/0012359 A1
(43) Pub. Date: Jan. 16, 2003

(54) Method and apparatus for simplified area code dialing

(76) Inventors: Jeffrey Nayhouse, Pittsburgn, PA (US); Edward Bullister, Weston, MA (US)

Correspondence Address: JEFFREY NAYHOUSE, 613 MACASSAR DRIVE, PITTSBURGN, PA, 15236, US

(21) Appl. No.: 09/804,011

(22) Filed: Mar. 12, 2001

(51) Int. Cl. H04M 1/00; H04M 3/00

(52) U.S. Cl. 379/355.01

(57) ABSTRACT

A telephone (100) is configurable to automatically dial an area code selected from an area code selection pad (104). Once selected, the selected area code is automatically prepended to subsequent outgoing calls until a different area code is selected. A processor (212) implements a safety feature overrides the automated system when emergency numbers are called. With this system, repetitive dialing of the area code for consecutive calls to the same area code is eliminated.

### FIELD OF INVENTION

This invention relates to apparatus and methods for dialing telephone numbers, and in particular to methods for reducing the amount of dialing required for repetitive connection to the same area codes.

### BACKGROUND

Telephone dialing has become more complex. The area code is included in the number as a routine part of many calls, even when made over short distances for local calls.

In some cases, dialing the local area code is required for all calls. In the US, the number including the area code requires a total of ten digits for each call, which is time consuming and can increase the hazards associated with dialing from a mobile cellular phone while driving a car.

A telephone that could reduce or eliminate the additional keystrokes needed to dial an area code would decrease the time and hazards associated with telephone dialing.

This invention returns the telephone to a simpler operation mode that has typically been used by people in the past. With this phone you will be able to dial only local digits for a local call without pushing any additional buttons for area codes. This convenience will benefit all users, particularly those who have difficulty with complex procedures, such as children, handicapped, and the elderly.

### SUMMARY

This invention provides a system for selecting area codes from a predetermined set programmed into the phone and saving the selection for subsequent calls. The programmed set of area codes is stored in non-volatile memory.

One embodiment of this invention has a set of physical push buttons, for selection of area codes, located adjacent to the numeric keypad. By pushing the push button the user selects the area code and de-selects any previously selected area code.

A virtual push button embodiment of this invention has a set of virtual push buttons that are displayed on an electronic display. By selecting a virtual push button, the corresponding area code is selected and all other area codes are de-selected.

A menu selection embodiment of this invention has a set of area codes that are organized and displayed to the user in a menu from which the user can select an area code and de-select all other area codes.

A voice input embodiment uses voice inputs to select area codes from a menu.

A mobile embodiment uses collects position information so that area codes in the telephone's geographical location can be automatically added to the menu.

A list of area codes from which to select is programmed and stored in non-volatile computer memory. A list of special sequences such as “9-1-1” is also stored in non-volatile memory.

A method and apparatus are presented to process and combine the area code information with the dialed number to quickly dial the number desired by the user.

### OBJECTS AND ADVANTAGES

An advantage of the invention is that, when dialing a number with the same area code as the previous number, zero additional keystrokes are required for the area code.

A further advantage of the invention is that when a different area code is needed, the different area code can be selected with a single push button or menu selection.

Yet a further advantage is that the method allows the selected area code to be overridden, so that emergency sequences such as “9-1-1” pass through without interference. This feature is essential for safety.

Yet a further advantage of the invention is that it can be implemented in an independent, self-contained telephone, compatible with existing telephone lines, using a method that is intuitively obvious to the user of an ordinary telephone.

### BRIEF DESCRIPTION OF THE DRAWING

The features, aspects, and advantages of the present invention will become better understood with regard to the following description, appended claims and accompanying drawing, where:

FIG. 1. shows a physical keypad embodiment of the invention showing a telephone 100 with a standard keypad 102 and a area code selection pad 104.

FIG. 2. shows a virtual keypad embodiment of the invention showing a telephone 100a with a standard keypad 102a and a virtual area code selection pad 104a on a display.

FIG. 3. shows embodiments that include menu input, voice input, and geographical inputs. FIG. 3 shows a standard keypad 102b, a virtual keypad 102c, an area code selection menu 120 on a display, a voice input microphone 122, and a geographical locator 124.

FIG. 4. shows a flowchart of the invention describing a method embodiment for dialing the area code.

### DESCRIPTION OF A PHYSICAL KEYPAD EMBODIMENT

Herein, the terms “programming” and “programmed” refer to entering numbers into nonvolatile memory to be used in subsequent calls. “Programmed” numbers are to be used in combination with keyed in numbers to generate code signals at a later time.

Herein, the terms “dialing” and “keying in” are equivalent and both refer to the real-time process of entering digits into a real-time input device to a telephone to generate code signals in the process of connecting to another telephone. “Dialing” and “keying in” can refer to entering these digits through pushing real or virtual push buttons of a telephone keypad, turning a telephone dial, speaking into a voice input device, or any other means of entering digits into a real time input device.

In contrast to “programming”, the terms “dialing” and “keying in” do not refer to entering digits into storage for use to connect at a later time.

The advantages of the current system are better understood by reference to the drawing.

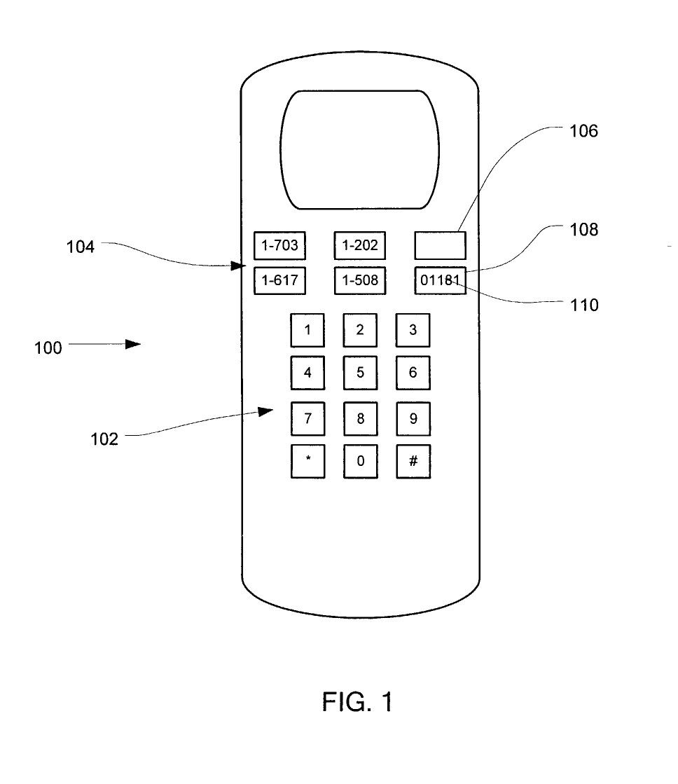

Referring to FIG. 1, a telephone 100 includes a keypad 102 and an area code selection pad 104.

The keypad 102 is of the standard type for dialing numeric telephone numbers.

The area code selection pad 104 contains push buttons for selecting area codes. The push buttons have two states: a selected state and an unselected state. The push buttons are configured such that at most one of the buttons is selected. Each button is associated with a specific area code indicated by a label adjacent to the push button. For example, the typical push button 108 has an associated label 110. The label 110 is marked with the digits “7-8-1”, which indicates that the area code 7-8-1 is associated with push button 108.

The push buttons of the area code selection pad 104 may be associated with area codes that specify a calling area for a local telephone number.

Push button 106 is the null push button. When push button 106 is pressed, no extra codes are dialed, and the telephone 100 operates in the manner of a standard telephone, in which only the numbers entered into the keypad 102 are dialed.

When other push buttons are pressed, for example, button 100, the area code associated with the pressed push button are transmitted before the manually dialed local number.

An aspect of these push buttons is that they retain information as to their state. The information as to which push button was last pushed is retained. The retained setting becomes the default for subsequent calls until this retained default is overridden by the user selection of an alternate push button for a new default.

Commonly, a user will call the same area code at least several times in a row. The above method of storing defaults requires zero additional buttons to be pushed to dial the area code for this commonly occurring case. If a different area code is desired, the user need push only a single additional button to dial the area code.

A further aspect of the push button is the display of the currently selected default. This enables the user to see or feel which default is selected in order to decide whether the default need be changed. A physical button such as button 108 in FIG. 1 can be illuminated when selected to distinguish it from the other unselected buttons. Alternately, a button such as button 108 can be latched to a depressed position when selected such that its physical location signifies that it is selected.

### DESCRIPTION OF A VIRTUAL KEYPAD EMBODIMENT

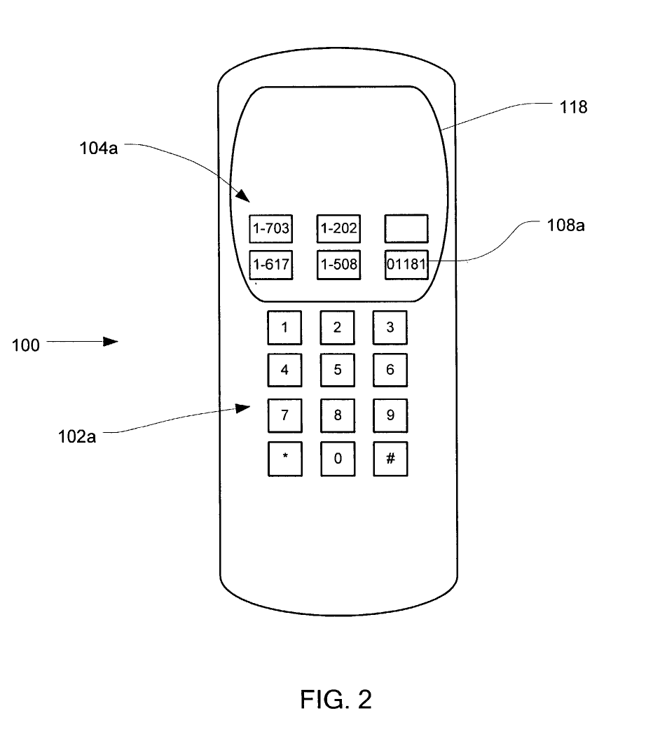

FIG. 2 shows a virtual keypad embodiment in which a telephone 100 includes a keypad 102 and a display 118. On the display 118, physical push buttons are simulated by interactive pictorial images of push buttons which constitute virtual push buttons such as the typical virtual push button 108a. These virtual push buttons are generated by electrical circuitry that can be built by those skilled in the art.

The virtual push button such as 108a on the display 118 can be given a different appearance when selected or pushed. Two edges of the rectangular button 108a can be extended and darkened to simulate a shadow. The appearance and disappearance of this shadow gives the button a different appearance representing the button being deselected or selected. The virtual push button can also be highlighted or otherwise changed in appearance to signify when it has been selected to contrast the appearance of the unselected push buttons.

### DESCRIPTION OF A MENU SELECTION EMBODIMENT

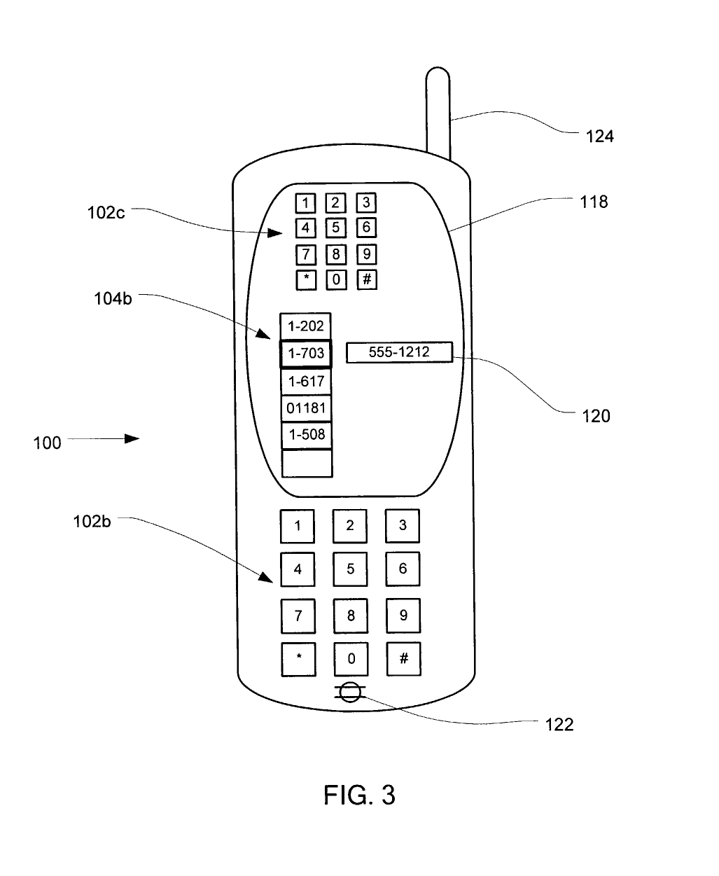

Referring to FIG. 3, a telephone 100 includes a keypad 102b and an electronic display 118 programmed to display an area code selection menu 104b. The telephone 100 also includes a virtual keypad 102c for keying in digits. The area code selection menu and virtual keypad are generated by electrical circuitry that can be built by those skilled in the art.

The area code selection menu 104b operates in a manner similar to the physical and virtual area code selection pads 104 and 104a of the keypad and virtual keypad embodiments. The menu 104b has a plurality of area codes, and selection of one area code deselects the other area codes. The selected area code is given an appearance that contrasts the deselected area codes so that the selected area code is apparent to the user.

This menu 104b is efficient in that it presents the user with a selection of a set of commonly used area codes from which to select. This selection may be expandable to display the number of area codes commonly used by the user.

Preferably, the deselected menu items disappear after the selection process. The menu 104b preferably displays only the selected area code to the left or above the displayed local number 120 dialed on through keypad 102b or 102c, so that a coherent, complete number is displayed to the user.

### DESCRIPTION OF EMBODIMENTS WITH VOICE INPUT AND GEOGRAPHICAL INPUT

Referring again to FIG. 3, a microphone for voice input 122 can be included with the telephone device for input selection of area codes. An antenna for geographical input 124 can be included to receive signals that contain information regarding the geographical location of the telephone. These signals can be, for example, signals from global positioning satellites (GPS signals) or handshake signals from local cellular communications towers. The antenna 124 receives these signals for use in including geographical information to automatically add area codes of areas proximate to the location of the telephone. These proximate area codes are likely candidates for desired area codes and can be added to a selection menu such as 104b.

In each of the above three embodiments, it is preferred that the selected area code is indicated in some form. This enables the user to see which area code is selected and prompts him to change the selected area code if necessary.

In each of the above embodiments, it is preferred that the set of area codes is programmable by the user. This allows commonly used area codes to be added. This also allows seldom-used area codes to be deleted, thereby simplifying the selection process.

### DESCRIPTION OF A METHOD EMBODIMENT

Another aspect of this invention is the method for processing the area code data. The method allows the selected area code to be overridden by direct dialing. The area code is overridden when the user initiates a dialing a special number sequence. When this happens, the selected area code prefix is ignored, and the verbatim dialing sequence is sent. For example, if the user initiates a dialing sequence beginning with the digit “1”, it is assumed that the user intends to manually dial an area code. Other examples of special number sequences are “4-1-1” and “9-1-1”. It is important that the device does not block special number sequences that correspond to emergency numbers. Herein, special number sequences are sequences of digits that are reserved and are not valid sequences for the beginning of a local telephone number. The number of such special sequences, even within the entire U.S., is small and stable and can all be programmed onto permanent memory of the device.

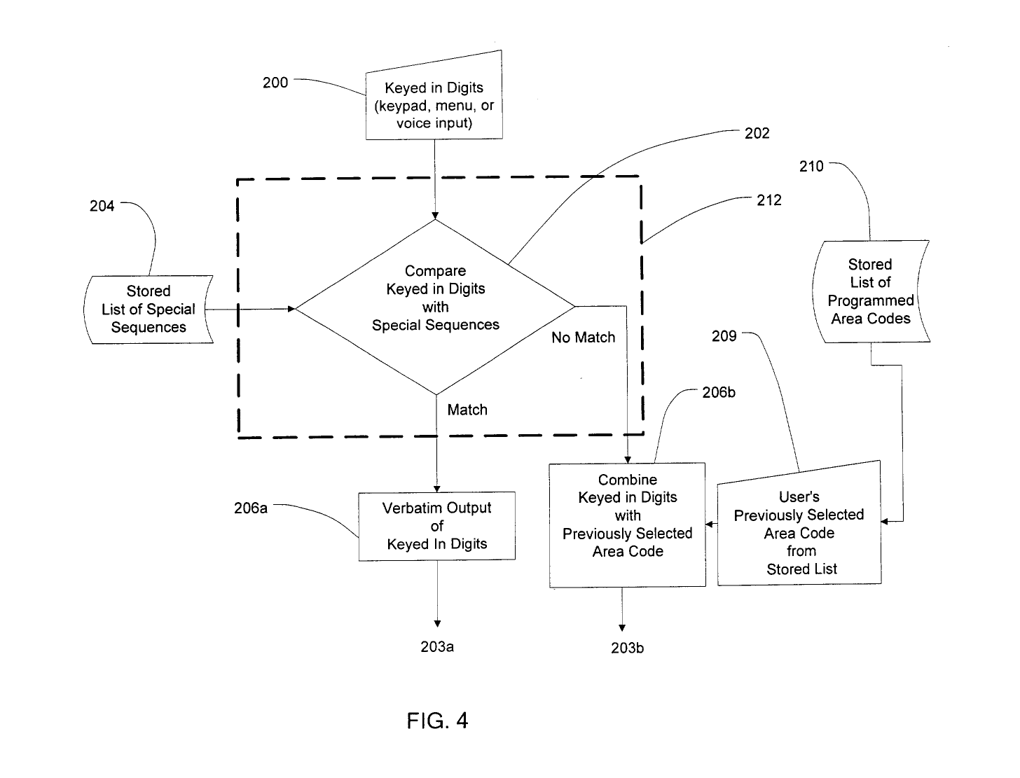

Referring to FIG. 4, an electronic processor 212 is able to receive electrical signals corresponding to the digits 200 keyed in by the user and is also able to receive from non-volatile memory electrical signals corresponding to programmed special sequences of digits 204. The processor 212 is programmed to compare these two signals and produce different electrical outputs depending on whether this comparison results in a match. These electrical outputs ultimately produce signaling codes 203a or 203b. Herein, “signaling codes” means codes representing a sequence of numbers used to identify a data path for connection to a remote telephone. These signaling codes 203 may be the dual-tone signals of tone-dial telephones commonly in use at the time of this application, optical signals, or any other form of signals to identify a path.

To enable the processor 212 to detect such special sequences before transmitting signaling codes 203, the processor 212 stores and evaluates the user's initial dialing sequence of keyed in digits 200 before sending any such codes 203. If the dialing sequence is a special number sequence, the processor 212 sends the verbatim keyed in digits to be output as signaling codes 203a. If the dialing sequence is not a special number sequence, the selected area code is prepended to the dialing sequence in step 206b, then both the area code prefix and the local number are sent as signaling codes 203b.

The method described above is diagrammed in the flow chart of FIG. 4.

Before the real time dialing occurs, a default area code is selected in step 209 from a list 210. This list 210 may be programmed in with manual input and with voice input. When the telephone is a mobile telephone, the list 210 may be automatically filled with area codes corresponding to the current geographic location of the mobile telephone.

During real-time input, the processor 212 accepts input 200 from the user. Referring to FIG. 3, this input from a keypad 102b, a voice input microphone 122, or any other input device. Referring now to FIG. 4, in step 202, the processor 212 compares the digits from the keyed input 200 with the digits of a list of programmed special number sequences 204 retrieved from storage. Step 202 continues until sufficient keyed in digits 200 have been entered to unambiguously determine whether the digits 200 can or cannot match any sequence from the list of special sequences 204.

If the result of step 202 is no, the special sequence is output verbatim in step 206a. Step 206a may run simultaneously in parallel with step 200. For example, a first keyed in digit “1” signifies to the processor 212 that the sequence must be a special sequence, and that the user is manually overriding the selected area code with a manually keyed in area code. Once this fact is established, all keyed in digits 200 may be immediately passed through verbatim as they are entered so that the transmission of the digits to initiate the call may begin without the delay of waiting for the whole sequence to be input.

If the result of step 202 is yes, the selected area code prefix from the list of programmed numbers 210 is retrieved from storage and transmitted before the manually keyed input in step 206b. This area code prefix had been previously selected in step 209 from a stored list 210. Step 206b may also run simultaneously in parallel with step 200. For example, a sequence of digits “965” currently is sufficient in the conventional US telephone system to signify to the processor 212 that the sequence is not a special sequence, and that the user's likely intent is to use the currently selected area code. Once this fact is established, the selected area code prefix can be transmitted, followed by all keyed in digits as they are entered. This minimizes the delays in waiting for the whole sequence to be input.

The foregoing discussion should be understood as illustrative and should not be considered to be limiting in any sense. While this invention has been particularly shown and described with references to preferred embodiments thereof, it will be understood by those skilled in the art that various changes in form and details may be made therein without departing from the spirit and scope of the invention as defined by the claims. For example, the telephone may be wired or wireless.

Having described the invention, what is claimed is:

1. A telephone, comprising:
a. a real-time input device for entering keyed in digits corresponding to local digits of a telephone number,
b. an area code selection device for selection of programmed digits corresponding to an area code of said telephone number,
c. memory storage for said programmed digits, and,
d. a processor programmed to retrieve from said storage and combine said programmed digits with said keyed in digits and transmit a signal corresponding to a combined telephone number that includes said keyed in digits and said programmed digits.

2. The telephone of claim 1, further comprising a processor programmed to compare said keyed in digits with a set of special number sequences and transmit telephone signal codes that are based on the result of said comparison.

3. The telephone of claim 2, wherein said real-time input device is a keypad.

4. The telephone of claim 2, wherein said real-time input device is a virtual keypad.

5. The telephone of claim 2, wherein said real-time input device is a voice input device.

6. The telephone of claim 1, further comprising nonvolatile electrical memory for storage of special number sequences.

7. The telephone of claim 1, further comprising a display.

8. The telephone of claim 7, further comprising electrical circuitry for display of virtual push buttons.

9. The telephone of claim 8, further comprising electrical circuitry for display of an area code selection menu.

10. The telephone of claim 9, further comprising electrical circuitry for selection of an area code from an area code selection menu.

11. A telephone, comprising:
a. a real-time input device for entering keyed in digits corresponding to local digits of a telephone number,
b. storage memory for storing signals representing programmed digits,
c. a processor programmed to:
i. retrieve from said storage signals representing programmed digits,
ii. combine said keyed in digits with said programmed digits,
iii. compare said keyed in digits with a set of special number sequences, and
iv. transmit a signal corresponding to a telephone number based on results of said comparison of said keyed in digits with said special number sequences.

12. The telephone of claim 11, further comprising:
a. an area code selection device for selection of programmed digits corresponding to an area code of said telephone number,
b. memory storage for said programmed digits, and,
c. a processor programmed to retrieve from said storage and combine said programmed digits with said keyed in digits and transmit a signal corresponding to a combined telephone number that includes said keyed in digits and said programmed digits.

13. A method for generating telephone signaling codes, comprising the steps of:
a. receiving electrical signals corresponding to digits keyed in by a user
b. comparing in a processor said digits to digits from a list of special number sequences
c. generating signals corresponding to signaling codes, said signals conditionally dependent on said comparison in said processor, and corresponding to sequences of digits conditionally selected from either:
i. said digits keyed in by said user, or
ii. preprogrammed area code digits.

14. The method of claim 13, wherein said keyed in digits are keyed in through a telephone, said telephone comprising:
a. a real time input device for entering keyed in digits corresponding to local digits of a telephone number,
b. an area code selection pad for selection of programmed digits corresponding to an area code of said telephone number, and,
c. a processor programmed to combine said programmed digits with said keyed in digits and transmit a signal corresponding to combined telephone number that includes said keyed in digits and said programmed digits.

15. The telephone of claim 1, wherein said area code selection device includes at least two push buttons for selection between two sets of programmed digits.

16. The telephone of claim 1, wherein said area code selection device includes at least two push buttons for selection between two sets of programmed digits.

17. The telephone of claim 1, wherein said area code selection device is a voice input device.

18. The method of claim 13 wherein said electrical signals corresponding to digits are generated by the telephone of claim 1.

19. The telephone of claim 1, wherein said telephone is a wireless telephone.

20. The method of claim 13, further comprising the step of inputting the geographical location of the telephone for selection of said preprogrammed area code digits.
